(19) United States
(12) Patent Application Publication
(10) Pub. No.: US 2020/0401887 A1
(43) Pub. Date: Dec. 24, 2020

(54) METHOD AND SYSTEM FOR AUTOMATICALLY DERIVING QUANTITATIVE DEEP LEARNING BEST VALUE INDEX DATA

(71) Applicants: Budi Kusnoto, Chicago, IL (US); ARYO HANDONO, CHICAGO, IL (US)

(72) Inventors: Budi Kusnoto, Chicago, IL (US); ARYO HANDONO, CHICAGO, IL (US)

(21) Appl. No.: 16/905,082

(22) Filed: Jun. 18, 2020

Related U.S. Application Data
(60) Provisional application No. 62/862,710, filed on Jun. 18, 2019.

(51) Int. Cl. G06N 3/08; G06N 3/04

(52) U.S. Cl. CPC G06N 3/08; G06N 3/04

(57) ABSTRACT

A method and system for automatically deriving and analyzing quantitative Deep Learning Best Value Index data is provided. The method and system to rank business processes based on multi-factorials and multi-facets parameters of best practice and using Artificial Intelligence (AI) to interpret and verify commonly used individual parameter data-points for specific business processes, weighted with predefined order and class (ranking), in which the sum of the total weight of all the parameters will be the dynamically morphing, applying AI deep learning output to create a dynamic value index (BVI—Best Value Index).

### CROSS REFERENCE TO RELATED APPLICATIONS

The following application is a based on and claims the priority benefit of U.S. provisional application Ser. No.: 62/862,710 filed on Jun. 18, 2019 currently co-pending; the entire content of which is incorporated by reference.

### BACKGROUND OF THE INVENTION

A method and system for automatically deriving and analyzing quantitative Deep Learning Best Value Index data is provided. The method and system to rank business processes based on multi-factorials and multi-facets parameters of best practice and using Artificial Intelligence (AI) to interpret and verify commonly used individual parameter data-points for specific business processes, weighted with predefined order and class (ranking), in which the sum of the total weight of all the parameters will be the dynamically morphing, applying AI deep learning output to create a dynamic value index (BVI—Best Value Index).

### SUMMARY OF THE INVENTION

The Best Value Index (BVI) method helps a patient to identify the best clinic based on parameters such as clinical condition, treatment price, availability and feedback rating based on dynamic weighting. The iSmartOffice™ process will assist clinics to increase their revenue by lowering operating cost especially on low peak periods.

Patient scheduling systems have been invented in the past. For example, U.S. Pat. No.: 9,971,873 to Schoenberg discloses a system wherein a request is received from a consumer of services to consult with a service provider having a service provider profile that satisfies at least some attributes in a set of attributes that define a suitable service provider; an available service provider satisfying at least some of the attributes in the set of attributes is identified; and a communication channel is provided to establish a communication between the consumer of services and the identified service provider.

Further, U.S. Pat. No. 8,396,735 to Lauffer discloses a method of (or apparatus for) facilitating the delivery of advice to consumers using a server unit which can store and display the names and characteristics of experts and then rapidly assist in connecting the expert and consumer for real-time communication. The server can also have the ability to receive keywords from the consumer, match those keywords to one or more experts, and tell the consumer how to contact an expert.

The present system is a combination of mobile applications and a web portal connected via common SQL database technology, then utilizing AI system algorithms to be allow process to perform tasks normally requiring human intelligence that can adapt to changing circumstances, as a guide to provide better services or create better products solving cognitive problems commonly associated with human intelligence to grow its business, improve its customer experience and selection, and optimize its logistic speed and quality that can be used to help managing service type business industry and its connectivity with potential clienteles.

The main system backend was developed by combining a well-known Content Management System with a JSON REST function, and serves both as mobile backend and portal interface.

A business process directed by the end-user (patients/clientele) involving highly specialized/highly skilled service industry (such as Dentistry), in which the fundamental/basic need of the end-users will be captured by either sets of questionnaires or through multiple input medias in the computer/mobile devices (such as its camera or other input devices) that can be translated to specific industry codes/in this example the ADA CDT Code) which will then matched with what the service provider can offer based on the BVI parameters (involving time, time zone, locations/geolocations, price, availability, special discounted slot/promotional, rating system, etc.

This business process will also handle the matching process/matching service in single or multiple entities of the associated business services with its service associates (multiple providers, i.e. multiple dentists/doctors, in multiple locations, i.e. clinics/hospital with its multiple support personnel i.e. office staff/dental-assistants) through seamless connectivity and data exchange via secured channel and HIPAA compliant data transmission to and from web portal, web services, mobile apps (iPhone/Android), API and other internet/air/Wi-Fi transmission and operable devices which might yet to be invented.

The method and system provides an artificial intelligence cognitive system, capable of interpreting deep learning BVI data to perform dynamic diagnostics and capable of recognizing, interpreting and evaluating such BVI data, both qualitatively and quantitatively. Finally, the computer system may utilize a blockchain algorithm through secured data measurement technology.

An advantage of the present method and system for automatically deriving and analyzing quantitative BVI data is that the present method and system is capable of identifying only normal behavioral data, but process provides for unique analysis and analysis of BVI data structures and surrounding to provide unique results.

An advantage of the present method and system for automatically deriving and analyzing quantitative BVI data is its ability to be adaptive and dynamic in arranging sequence based on parameters set (such as distance, availability, price, reviews, etc.). The system utilized data analytic as well as deep learning capability to automatically adjust the weight and priority of each parameters based on user profile and preferences.

For a more complete understanding of the above listed features and advantages of the present method and system for automatically deriving and analyzing quantitative BVI data system reference should be made to the detailed description and the detailed drawings. Further, additional features and advantages of the invention are described in, and will be apparent from, the detailed description of the preferred embodiments.

### BRIEF DESCRIPTION OF THE DRAWINGS

FIG. 1 and FIG. 2 illustrates a flow chart of the present BVI data analysis method and system in a first embodiment.

FIG. 3 and FIG. 4 illustrates a flow chart of the present BVI data analysis method and system in a second embodiment.

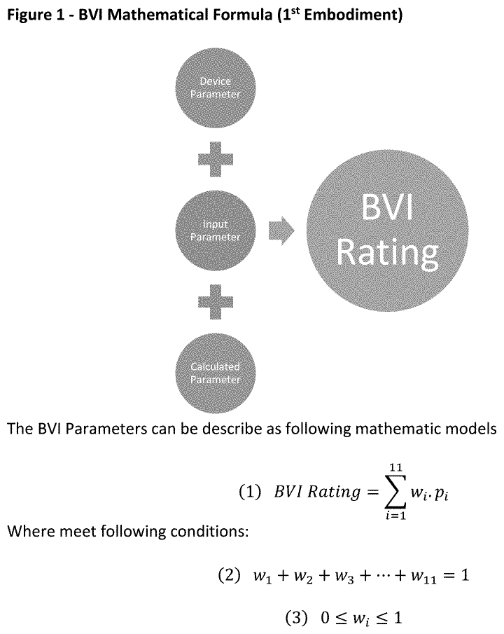

### DETAILED DESCRIPTION OF THE PREFERRED EMBODIMENTS

### Deep Learning Dynamic BVI

Best Value Index (BVI) is an index that can be used to rank certain business process based on multi-factorials and multi-facets parameters of best practice and commonly used for a specific business process. The index will take into consideration of individual parameter weight with predefined order and class (ranking) in which the sum of the total weight of all the parameters will be the value of the index (BVI—Best Value Index).

The ranking and the weighing of each parameters are define based on sets of agreeable common way of valuing services (can be tangible or intangible), such as rating of the facility, social media exposure and engagement, hit in the website, client conversion rate, flexibility of service, availability of service, range of service being provided, the reliability of the service provider, the experience of the service provider, the price range of the service and many more which all add to the total valuation of the business (service itself).

BVI is not a simple rating, but it is also based on statistical profile of each parameters (such as 25th percentile, 50th percentile, the top 1%, etc.). All parameters are being processed first through the peer-databased where all clients providing the same services being hosted (collected), upon statistical analysis and ranking, each parameter and their individual rank will be reprocessed and integrated by multiplying this rank to the predefine rank as well as the predefined weight which makes up to be BVI (Best Value Index).

As an example, a Dental clinic that has wide range of services, a good review of the doctors, with specialists doing the work, but may not be the lowest in price might have a significantly higher BVI then their competitor with the lowest price, but not so good overall review, and don't have a specialist in their group to consult.

Dynamic BVI is BVI in which the weight of each parameters adapts to the profile and the preference of each users. Some users prefer price over time over distance, others prefer convenient over price or services. Deep learning dynamic BVI, is the integration of AI and its deep learning capability to recognize those subtle individual preferences thus making inference of those based on each user profile. (Budi Kusnoto, 2018).

Most clients looking for a highly specialize service often time got disappointed when learning that the search engine prompt them to be somewhere where they actually do not do that specific procedure. In the same time clients are looking for a service provider that can fulfill their need, do a good job with warranty, good review, close to their location and available soon with descent price range. On the other hand, the business service provider often time got frustrated by failing appointments, unused available slot in their appointment book as well as arranging their own internal schedule for any associates or independent contractors working in their business to provide the services. In this millennial generation clienteles and business service providers, a combination that can bridge the need of business owner to be able to promote their low-season OR low-appointment time at a discounted rate, and coordinate service coverage at all time and synchronize operation with their existing management system is a great asset to have. In the same time, an apps that can link directly and provide specific specialize guidelines to the potential clients looking for specialize services (such as in healthcare/ dental industry) will be desirable. An apps that can dig in specific need based on specific questionnaires for specific highly specialize service industry will save a lot of time and redundant work at the client side as well as the business service provider side.

In a service industry where reimbursement/payment came from 3^{rd} party/insurance, this combination between apps and insurance codes as well as UCR (Usual Customary and Reasonable price) can streamline service and direct client to precise service providers.

The enhance feature of the apps can even perform verification system back to the client and business provider to whether the service has been rendered and has been rendered successfully with great satisfaction on both parties. As a business service provider, they can also perform push notification on the on-going promotions that they may have which can be set at a given time frame, or appointment slot or a combination of both. A BVI™ system (Best Value Index) can also be performed to ensure Search Engine Optimization by BVI™ such as combination between service available, price range, location, review, availability of certain providers for specific service, etc. With the ability to be combined as diagnostic delivery methods, iSmartOffice™ system and its Deep Learning and AI capability can begin to learn and identify customary/habits/preferences of each users to what kind of services/treatment that the individual users required, what kind of insurances codes as well as reimbursement that each users need. The analytic engine can be used to perform diagnostic as second opinion as well as to improve service to the client in this service-oriented business. Link with its click-per pay as well as pre-paid service features, the iSmartOffice™ system is a fully integrated B2C and B2B system.

The computer may acquire the data (or “insert asset”) from different sources. With respect to the [AI Server], the system may acquire the data through several possible modalities including, but not limited to: a) JPG, PNG, BMP, GIF, etc.) and/or b) 3D file format).

From a technical standpoint, the method and system may also have/allow:

1) End-user (client) components and Back-end components (cloud or locally deployed);

2) Client, In-browser and App applications handling input and output;

3) Back-end components for security, authentication and privacy;

4) Back-end components for accounts administration and online-payments;

5) Back-end web-server handling requests and communications with AI Server proprietary cognitive applications;

6) Back-end proprietary cognitive applications, handling all required functionality; and

7) Server-side persistance, multiple technologies.

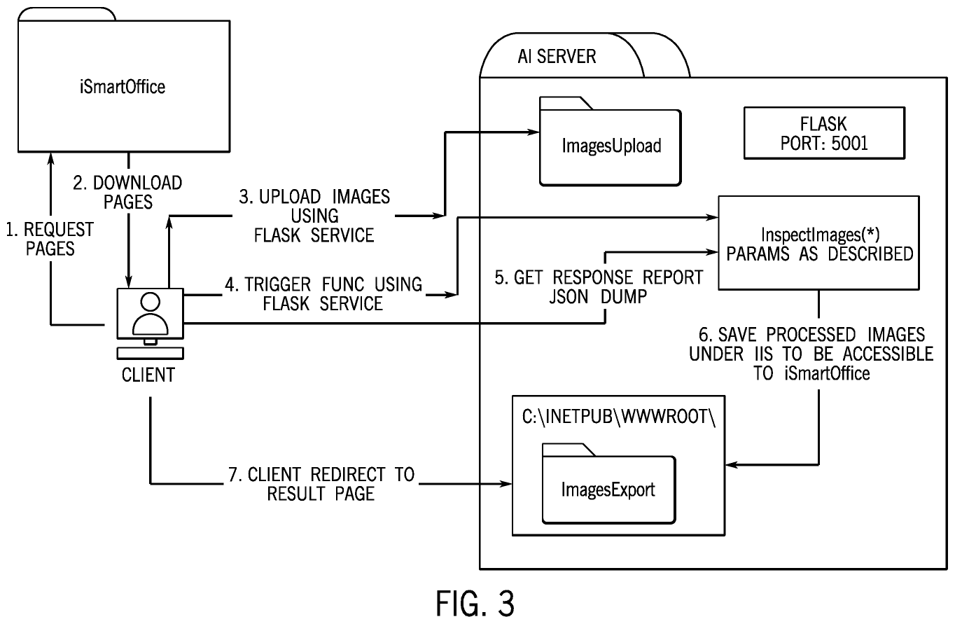

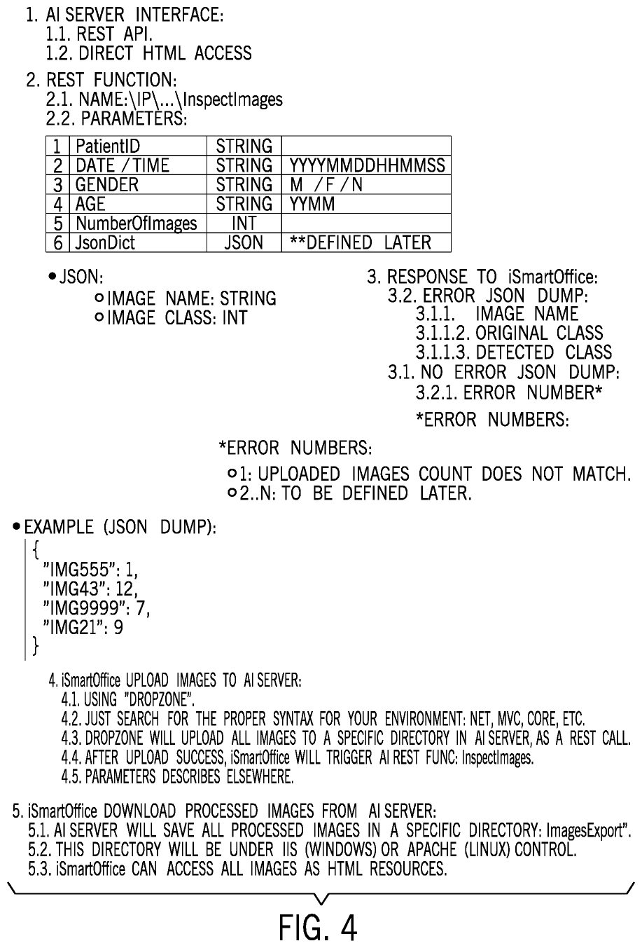

Another original and critical feature of this embodiments is the use of integrated channel to interpret result of digital imaging (visualization) machine learning process particularly derived from medical/dental imaging/data records pertaining to difficulty assessment of dental clinical condition. The process of Integrated AI driven generated of Case Difficulty Assessment can be found in FIGS. 3 and 4.

AI driven methods will analyze, categorize, identify certain dental condition/characteristics and translate those condition to qualitative/quantitative available indices value that relates to the degree of difficulty of the case. Further processing will also map the degree of difficulty assessment indices to standardized coding for treatment such as ADA CDT codes or SNODENT/SNOMED (not limited) which can be utilized for further processing to optimize the BVI as mentioned in the previous embodiment.

Methods/stages of developing AI driven Case Difficulty Assessment Using parameters guidelines as outline below, the case difficulty assessment index was derived with 0, 1-4 rating system (0=N/A). The variables on the guidelines were carefully picked from most commonly used variables (representing both quantitative and qualitative variables) of several validated dental indices used, developed and published in the area of dentistry. (See references below).

Several experience and well calibrated dentists of different specialties assessed the validity of the indices and their assessment with inter and intra reliability of at least 90% using 400 cases×5 basic images class×4 randomly selected specialized examiners×2 time points=totaling of 16,000 variety of instances. Further calibration utilizing 1,000 validation cases×5 basic images×4 randomly selected specialized×2 time points totaling 40,000 instances were used and run into the AI Matrix (CNN) to corresponds the indices with clinical photographs (imaging data).

The result is a well-trained AI Matrix capable of identifying at least 3 major specialty needs in dentistry which encompassed more than 70% type of dental conditions. General dentistry, restorative dentistry, implants, missing teeth, oral hygiene, gum disease (periodontics) and misaligned teeth (malocclusion) via Orthodontics.

Using input as clinical photographs, radiographs and 3D images, the developed AI Matrix will be capable of classifying a case in to 5 different main difficulty assessment groups, those are orthodontic, restorative, periodontics, total difficulty as well as cost assessment. Each assessment will result in 0, 1-4.
0. N/A
1. Lower difficulty
2. Moderate difficulty
3. Difficult
4. Very difficult

Each of the parameters were then being reported back to the front-end as string, as an example (12312) meaning 1 for parameter 1, 2 for parameter 2, 3 for parameter 3, 1 for parameter 4, and 2 for parameter 5.

The string will then be deciphered and mapped through mapping process as described in the previous page to the standardized coding system (such as ADA CDT code) which then give weight/value to the suggested minimal dental treatment needed as well as minimal estimated cost to resolve the problem.

Example of the weighted translation based on the AI results are as follows

### Orthodontic Treatment Need

0. No orthodontic treatment needed
1. Some teeth alignment are needed (esthetic)—D0150, D0330, D8040
2. Teeth alignment are needed (esthetic and function) to be performed by specialist—D0150, D0330, D0340, D8080
3. Teeth alignment are needed to be performed by specialist with higher degree of complexity—D0150, D0330, D0340, D8090
4. Very complex case in need for major tooth alignment for health, function and esthetic reason. In need of specialist(s) and dental team effort (multidisciplinary approach)—D0150, D0330, D0340, D8090

### Periodontic Treatment Need

0. No periodontic treatment needed
1. Some dental/oral hygiene maintenance is recommended—D0180, D0210, D4910
2. Some gum problem/potential problem detected. Dental visit to periodontal specialist is recommended. D0180, D0210, D4341, D4341, D4342, D4342
3. Major gum/bone graft condition might be needed and done by specialist. D0180, D0210, D4341, D4341, D4342, D4342, D4285
4. Very complex case in need for major periodontal (gum) rehabilitation for health, function and esthetic reason. In need of specialist(s) and dental team effort (multidisciplinary approach)—D0180, D0210, D4341, D4341, D4342, D4342, D4283, D4285

### Restorative Treatment Need

0. No restorative treatment needed
1. Some dental/oral restoration is recommended (possible filling, cavities)—D0160, D0210, D0601, D2330, D2390
2. Possible tooth lost needing replacement or restoration is needed. Dental visit to a dental specialist is recommended. D0160, D0210, D0602, D2330, D2390, D2783
3. More complex dental restoration procedure is needed and done by specialist—D0160, D0210, D0603, D2330, D2390, D2783, D2962
4. Very complex case in need for major restoration for health, function and esthetic reason. In need of specialist(s) and dental team effort (multidisciplinary approach)—D0160, D0210, D0365, D0603, D2330, D2390, D2783, D2962, D6066, D6069

### Total Case Assessment Difficulty

### 0. Easy+D9310×0

1. Lower difficulty+D9310×1
2. Moderate difficulty+D9310×2

### 3. Difficult+D9310×3

4. Very difficult+D9310×4

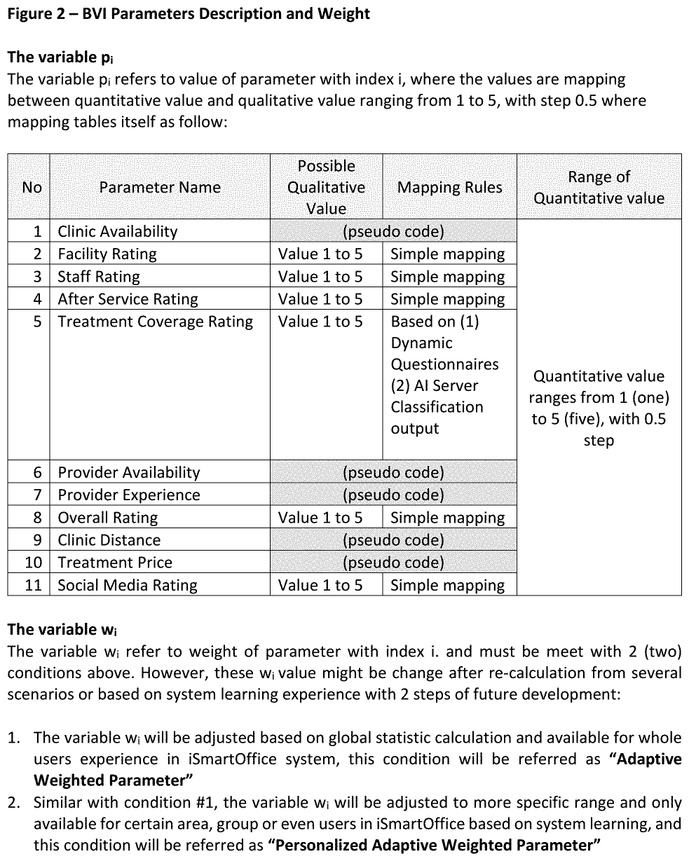

The improved BVI algorithm also has the ability to absorbed any input derived or reported by AI analytical engine (via JSON protocol) and REST API FIG. 2.

The output reports will be deliver using HTTP/HTTPS protocol, it can be JSON, XML or even a direct HTML and will be decipher based on set user end parameters (such as degree of difficulty of certain condition, qualitative or quantitative of certain outcome assessment etc), to be then used as part of the BVI weighing system while the system perform BVI analytical search based on multiple predefined parameters (each with specific weight/order of priority).

Those mapped standardized codes then will be used to automatically fill in the BVI questionnaires (BVI Input methods #1) mentioned as another methods of search weighted in the previous embodiment.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1. A system for automatically deriving and analyzing quantitative Best Value Index data comprising:
a first computer for calculating a Best Value Index Artificial Intelligence based data analytic algorithms that perform dynamic weighing of a Bayesian system logic to provide users with inference of best options based on user preferences and the BVI deep learning capability;
a second computer incorporating artificial intelligence for interpreting the digital Best Value Index data and dynamic user data; and
wherein the second computer generates custom user guided option sets based on their previous experiences as well as new dynamic questionnaires generated for specific line of business.)

2. A system for translating and interpreting Artificial Intelligence derived qualitative and quantitative data obtained on-line, wherein the system:
classifies, categorizes and analyzes the Artificial Intelligence obtained on-line and validates and standardizes the data into values and indices that relate to a degree of difficulty in specific problem/case.

3. The system of claim 2 further comprising:
the processing and mapping of the indices to standardized coding for treating ADA CDT codes and or SNODENT/SNOMED which can be utilized for further processing to optimize a Best Value Index.
